(19) United States
(12) Patent Application Publication
(10) Pub. No.: US 2019/0058585 A1
(43) Pub. Date: Feb. 21, 2019

(54) Matter-Based Photon Quantum Encryption Device

(71) Applicant: Corey Reaux-Savonte, London (GB)

(72) Inventor: Corey Reaux-Savonte, London (GB)

(21) Appl. No.: 16/103,586

(22) Filed: Aug. 14, 2018

(30) Foreign Application Priority Data
Aug. 16, 2017 (GB) GB1713137.6

(51) Int. Cl. H04L 9/08

(52) U.S. Cl. CPC H04L 9/0852

(57) ABSTRACT

A quantum encryption device that uses matter to interfere with passing photons to create random light patterns which are used to create encryption keys.

### FIELD OF THE INVENTION

The disclosed embodiments relate to physics and engineering.

### BACKGROUND

Quantum encryption devices for everyday use in common devices have been theorised but not realised due to the current unreliability of many required factors. That is no longer the case.

### SUMMARY

The disclosed invention is a quantum encryption device that uses matter interfering with photons to create random light patterns which are used to randomly generate encryption keys.

In an aspect of the invention, the device uses matter to interfere with beams of light in order to create completely random light patterns.

In another aspect of the invention, the device uses random light patterns to generate encryption keys.

### DESCRIPTION OF DRAWINGS

FIG. 1

An example of a simple matter-based photon quantum encryption device.
101—Laser.
102—Detector.
103—Matter field within a container.
104—Laser beam.
105—Extraction system.
106—Insertion system.

FIG. 2

An example of the process and resulting pattern.
201—Laser.
202—Laser beam passing through matter field.
203—Detector.
204—Example of resulting pattern.

FIG. 3

An example of a more complex matter-based photon quantum encryption device.
301—Inner matter field.
302—Outer matter field.

### DETAILED DESCRIPTION OF EMBODIMENTS

Reference will now be made in detail to embodiments. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The term “laser” can be taken to mean “photon source”.

The term “matter field” refers to both the matter particles and the container within which they are situated.

The various applications and uses of the invention that may be executed may use at least one common component capable of allowing a user to perform at least one task made possible by said applications and uses. One or more functions of the component may be adjusted and/or varied from one task to the next and/or during a respective task. In this way, a common architecture may support some or all of the variety of tasks.

Unless clearly stated, the following description is not to be read as:
the assembly, position or arrangement of components;
how components are to interact; or
the order in which steps must be taken to compose the present invention.

Attention is now directed towards embodiments of the invention.

This device relies on the freedom of movement of matter particles within a container, and how they can interfere with photons. By firing photons through a field of freely moving matter particles, the particles interfere with the photons—refracts them, absorbs them, modifies energy, reduces intensity etc—and this interference creates randomised light patterns on the detector. The higher the resolution and more sensitive to light the detector is, the greater the detail that can be defined. The detector then uses those patterns to create encryption keys. The forever changing positions of freely moving particles create a forever changing light and shadow pattern against the detector, meaning a pattern and the associated key created from it can only ever be guessed, but never calculated.

The matter field needs to consist of either:
entirely gas particles; or
solid or gas particles floating in a liquid.

Using only gas particles is the better method of the two, as they will randomly float around the available space naturally, while solid or gas particles floating in a liquid requires continual motion to mix them.

Additional steps can be taken to further increase the randomness and security of the encryption. Each of the following is an example of an embodiment which may be used individually or in conjunction with one or more other embodiments:
Coloured Gases—Using coloured gases to act as filters/blockers, combined with a detector which not only senses light but also colour, increases the degree of randomness and security by adding another factor for consideration. As well as needing to determine the intensity pattern, someone would also need to determine the change in shade from the original colour of the light as it is altered to varying degrees by the gas particles. For example, if the beam of photons start off as white light, but pass through a matter field of red particles, the resulting pattern would be various shades of red, white, and even near black if enough particles were in the way. If the original light was red and blue gases were used, the resulting pattern would be blue and black. If multiple gases of different colours were used, a multicoloured pattern could be produced. It would all depend on gas particle population and clustering at the moment in time of the laser passing through.
Coloured Crystals—The same as the above, except coloured crystals act as filters/blockers and are used within liquids.
Insertion/Extraction Systems—Using insertion and extraction systems, such as fans, the particle population within the matter field can be changed at will. By changing the population, the possible number of patterns change, decreasing the probability of any person cracking an encryption key created.
Multiple Lasers/Detectors—Additional lasers and detectors can be used to simultaneously create multiple patterns, which can be used collectively to create a single encryption key, or to be switched between for use.
Multiple Laser Colours—Multiple laser colours means someone would need to know the colours used, when each was used, whether or not multiple colours were fired simultaneously, the exact pattern created, and the algorithm used in order to crack the key.
Changing Encryption Algorithms—A regularly changing algorithm means that, if it just so happened that the exact same pattern was created at any two points in time, the odds of the exact same encryption key being generated lowers.

In some embodiments, a second matter field is required. If liquids or coloured gases are used along with insertion and extraction fields, the second matter field is required to prevent liquid leakage, or coloured gases from being replaced with colourless gases. It needs to be completely sealed and air tight.

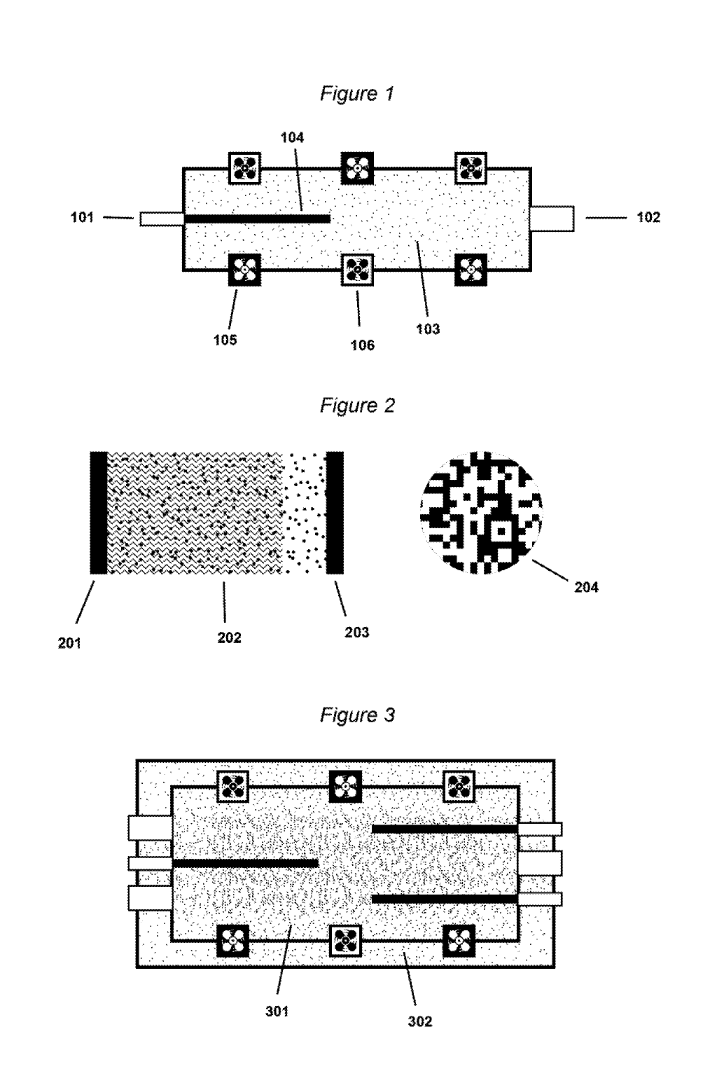

FIG. 1 is a basic example of the device, featuring one laser, one detector, insertion and extraction systems, and a single matter field. With insertion/extraction systems in place but no second matter field, this example couldn't rely on liquid or coloured particles, but solely on refraction, absorption, energy modification, and intensity. FIG. 2 is an example of the process and the result, where laser 201 is firing beam 202 through a matter field to detector 203. Pattern 204 is an example of a possible resulting pattern.

FIG. 3 is an example of a more complex device, featuring multiple lasers aimed in multiple directions, insertion and extraction systems, and inner and outer matter fields. This setup would allow for the use of liquids and coloured gases, as they will simply be transferred between matter fields without any loss to the surrounding environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A quantum encryption device, comprising:
one or more lasers;
one or more matter fields; and
one or more detectors;
wherein:
a laser fires photons through a matter field towards a detector;
free moving matter within the matter field through which the photons pass interfere with the photons;
photons hitting the detector create a light pattern based on the interference of the matter they encountered; and
the light pattern is used as the basis for an encryption key.

2. The quantum encryption device of claim 1, wherein coloured matter is used as colour filters and blockers.

3. The quantum encryption device of claim 1, wherein insertion and extraction systems are used to change the particle population of a type of matter within a matter field.

4. The quantum encryption device of claim 1, wherein multiple laser colours are used.

5. The quantum encryption device of claim 1, wherein a changing algorithm system is implemented to reduce the likelihood of the same pattern creating the same key.

6. A method of creating encryption keys, the method comprising:
firing photons through a matter field towards a detector;
allowing free moving matter within the matter field to randomly interfere with said photons;
using a detector to sense the light pattern created by the impact of the photons; and
using the light pattern as a basis for an encryption key.

7. The method of claim 6, including using coloured matter for variations.

8. The method of claim 6, including using insertion and extraction systems to change the particle population of a type of matter within a matter field.

9. The method of claim 6, including using multiple laser colours for variations.
